(19) United States
(12) Patent Application Publication
(10) Pub. No.: US 2004/0096563 A1
(43) Pub. Date: May 20, 2004

(54) C.M.C. thickening agent

(76) Inventor: Michael Edward Writt, Indianapolis, IN (US)

Correspondence Address: Michael E. Writt, 7155 Wadsworth Way, Indianapolis, IN, 46219, US

(21) Appl. No.: 10/292,005

(22) Filed: Nov. 12, 2002

(51) Int. Cl. A23L 1/05

(52) U.S. Cl. 426/573

(57) ABSTRACT

Sodium carboxymethylcellulose is a water-soluble anionic linear polymer. It is known universally as C.M.C. In the food and pharmaceutical industries the purified product is known as cellulose gum.

Cellulose is a linear polymer of B-anhydroglucose units. Each anhydroglucose unit contains three hydroxyl groups. C.M.C. is prepared by the reaction of the cellulose hydroxyls with sodium monochloroacetate as follows.

RecellOH+NaOH+CICH2COONa−ROCH2COONa+NaCI+H2O. The extent of the reaction of cellulose hydroxyls to form a derivative is called the degree of substitution (DS) and is defined as the average number of the three hydroxyl groups in the anhydroglucose unit which have reacted. Thus, if only one of the three hydroxyl groups have been carboxymethylated, the DS is 1.0. Commercial products have DS values ranging from 0.4 to about 1.4. There are many producers and a wide range of DS viscosity's available. The highest purified form (99.5+) is the type used for this application. The FDA, the Food Chemicals Codex and the Food and Agriculture Organization of the United Nations World Health Organization will recognize C.M.C. (99.5+% purity) as a direct food additive.

### INVENTION

Using cellulose gum (C.M.C.) sodium carboxymethylcellulose as a thickening agent to thicken liquids or puréed foods for persons with dysphasia or other swallowing problems. The C.M.C. can be used alone o or mixed with a dispersing agent to allow the C.M.C. to hydration. Some of the dispersing agents are but not limited too glucose, fructose, maltodextrin, dextrose, glycerin. C.M.C. can be mixed or sprayed with surfactants, or wetting agents to help hydrate. Some of the surfactants, or wetting agents are but not limited to lecithin, polysorbates, or any item used to spray C.M.C. to pre-wet the C.M.C. and re-dry for later mixing in liquids to help the hydration process.

### FIELD OF INVENTION

This invention allows people who have lost the involuntary control of swallowing due to stroke, illness or other disease. By thickening liquids or food with cellulose gum this allows the persons to consume the thickened liquids or puréed foods. Without aspirating or choking on liquids that are too thin and flow into the wind pipe causing the air to be cut off. The foods must be puréed and then thickened with cellulose gum to contract the flow through the throat to the stomach. As this type person can not consume large sizes of food, or thin liquids. There are thousands of this type of patients. Cellulose gum is colorless, tasteless and provides a product that is more acceptable to the person consuming the product. Thus helping prevent dehydration with all its problems and gives the person a better quality of life.

### BACKGROUND OF INVENTION

There is a large amount of people with swallowing problems, who have lost their involuntary control to swallow. This can be caused by any number of things, stroke, illness, disease or injury. This problem is classified as dysphasia. They must have liquids thickened as well as their foods must be consumed in small amounts, in different degrees of thickness (viscosity) to prevent aspirating or choking. Without using this method the persons will lose weight and become dehydrated, causing chronic loss of hydration which can lead to death if not checked. The food thickener now in use are mostly made up of starch's which taste like glue when mixed in water, and mask the flavor and change the taste of other liquids and foods. They also continue to thicken with time and become to thick to drink. This invention address this problem, by using cellulose gum alone or mixed with a dispensing agent to control the thickness or viscosity. The degree of thickness can be set to the needs of the patient.

### SUMMARY OF INVENTION

C.M.C. cellulose gum will reach the pre-determined degree of thickness in five minutes, will maintain this pre-set thickness indefinitely or until served. Allowing greater control of the thickness or viscosity needed for different individuals, depending on their needs. Depending on the severity of their problem. This allows the persons mixing the liquids or pureed foods to have more flexibility when they mix the products and the variety of foods that can be offered for the individuals with these problems. C.M.C. will thicken any liquids hot or cold, will not effect or distort the taste of any liquid or pureed food. C.M.C. is colorless, odorless and tasteless which makes it well suited for this application

1. What I claim my invention is. A better way to thicken liquids or puréed foods. The use of cellulose gum (C.M.C.) as a thickening agent to thicken liquids and foods for persons with dysphasia and other swallowing problems. Cellulose gum can be mixed with a dispersing agent or added independently to liquids or purred foods to thicken the liquids or pureed foods to a designated viscosity depending on the degree of thickness needed. The liquids or food can be thickened to the thickness needed as the disease progresses. The amount of cellulose gum can be tailored to the patients needs. Cellulose gum produces a clear, tasteless product when mixed with water. It does not change the taste or color of any liquid or food, allowing the person drinking the thickened liquids to taste the liquid or pureed food not the thickening agent. This is unique to cellulose gum.
